(19) United States
(12) Patent Application Publication
(10) Pub. No.: US 2003/0183342 A1
(43) Pub. Date: Oct. 2, 2003

(54) Device for producing a disk-shaped data carrier

(76) Inventor: Heinrich Spreizer, Ermatingen (CH)

Correspondence Address: NOTARO AND MICHALOS, 100 DUTCH HILL ROAD, SUITE 110, ORANGEBURG, NY, 10962-2100, US

(21) Appl. No.: 10/221,301

(22) PCT Filed: Mar. 5, 2001
(86) PCT No.: PCT/CH01/00133

(51) Int. Cl. B32B 31/00

(52) U.S. Cl. 156/382; 156/556

(57) ABSTRACT

The invention relates to a device for joining two disks (12, 14) to give a disk-shaped data carrier. Said disks that are coated with an adhesive (16) and provided with a center opening (18) are made from a material that contains plastic as the essential component. The inventive device comprises two retainer elements (40, 42) having a planar surface as the supporting surface for the disks (12, 14). Suction ducts (78, 80) lead to the surface of the supporting surfaces and generate a negative pressure that retains the disks (12, 14) on the supporting surfaces. Every retainer (40, 42) is disposed within a chamber half (24, 26) defining when closed a joining chamber (21) with a cavity that can be evacuated. Every chamber half (24, 26) is provided with a centering pin (62, 64) penetrating the retainer elements (40, 42) for the purpose of centering the disks (12, 14). In order to join the disks (12, 14) coated with the adhesive (16), at least one retainer element (40) can be displaced in its chamber half (24) in the direction (z) towards the other retainer element (42). The centering pins (62, 64) can be retracted into the supporting surface and their front faces that face each other when the joining chamber (21) is closed are adapted to engage with each other. The invention provides a means for producing disk-shaped data carriers of the DVD type in an essentially tension-free manner, with high surface evenness and excellent plane parallelism of their surfaces.

The invention relates to a device for joining two disks, coated with an adhesive agent and provided with a central opening and comprised of a material of which synthetic materials are a substantial component, to form a disk-shaped data carrier, with two retaining elements for the temporary retaining of the disks to be adhered with one another, with the retaining elements having a planar surface as seating faces for the disks coated with the adhesive agent, and suction lines for generating an underpressure retaining the disks on the seating faces terminating on the surface of the seating faces, with each retaining element being disposed within a chamber half and after closure forming a joining chamber with an evacuatable interspace, with each chamber half comprising a centering pin penetrating the retaining elements for centering the disks on the retaining elements, and with at least one retaining element being movable in its chamber half in the direction toward the other retaining element for the purpose of joining the adhesive-coated disks.

Disk-shaped data carriers of the type DVD must have extremely high planarity. To attain sufficient stability the data carriers are produced by adhering two disks, wherein conventionally one disk serves as a support disk and the other disk as the data disk proper. However, the data carriers can fundamentally also be comprised of two data disks adhered with one another.

For observing the required narrow planarity tolerances as well as additionally the plane-parallelity of the two disk surfaces during the adhesion of the disks, after the adhesion process strict attention must be paid that when joining the adhesive-coated disks no stresses are introduced into the disk composite and the disks are maintained in plane-parallel position during the adhesion process.

In known joining methods the adhesive-coated disks are held by retaining elements and joined force-free. The disks joined in this manner are subsequently subjected to a compression operation to increase the adhesive strength and for the final curing of the adhesive agent.

A device of the above described type is disclosed in DE-U 299 04 325. In this known joining station the centering pins are always extended out due to spring force. With the closure of the form the planar front faces abut one another planarly and are force-lockingly fixed by spring force alone.

While the narrow tolerances with respect to planarity and plane-parallelity of the surfaces required in the case of DVD type data carriers can be attained with the joining method according to DE-U 299 04 325, however, the compression operation proper must be carried out on an additional compressing station.

The invention is therefore based on the task of providing a device of the above described type with which data carriers of DVD type with high planarity and excellent plane-parallelity of surfaces can be produced and which has a centering means which makes possible to carry out the compressing operation directly in the joining station.

The solution according to the invention of the task comprises that the centering pin can be retracted beneath the seating face of the retaining elements and their front faces opposing one another when the joining chamber is closed are implemented such that they can engage into one another with self-centering.

With the implementation according to the invention of the centering pin, a disk composite results which, on the one hand, is free of air inclusions in the adhesion face and, on the other hand, has no or only extremely low mechanical stresses.

Each centering pin is usefully slidable in the axial direction by means of separate lifting mechanisms with each centering pin preferably being supported slidingly in a sleeve.

In a specially preferred embodiment of the joining station according to the invention at least one retaining element is in contact on a plunger piston movable in the axial direction or is formed by it. Optimum guidance of the plunger piston within the joining chamber can be attained thereby that the plunger piston is supported slidingly between the inner wall of a chamber half and the outer surface of the associated sleeve.

The plunger piston is usefully pneumatically actuatable.

The seating faces of the retaining elements are fabricated as pads preferably comprising synthetic materials and are surface-ground. The pads are conventionally approximately 1 to 8 mm thick and have a hardness of approximately 60 to 90 Shore. Suitable synthetic material are for example polyurethane, silicon or fluorine rubber and are optionally electrically conducting in order to have antistatic effects.

In a preferred embodiment of the device according to the invention the two chamber halves are pivotable from the open into the closed position about a common rotational axis.

To attain precentering of the joining chamber, the margin regions of the joining shell and of the cover, which during the closing of the joining chamber are opposing one another, can be implemented such they can self-centeringly engage one another and can be oriented plane-parallel with respect to one another.

An especially preferred application field of the device according to the invention is the production of disk-shaped data carriers of DVD type.

Further advantages, characteristics and details of the invention are evident in the following description of preferred embodiment examples as well as in conjunction with the drawing. Therein depict schematically

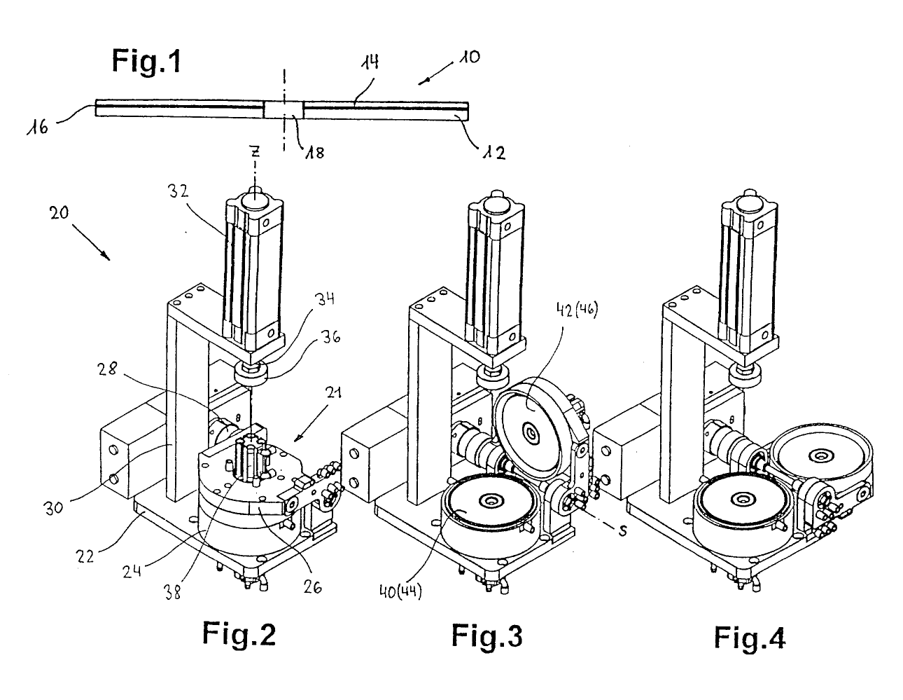

FIG. 1 a cross section through a disk-shaped data carrier,

FIGS. 2-4 an oblique view onto a joining station in different opening stages of the joining chamber,

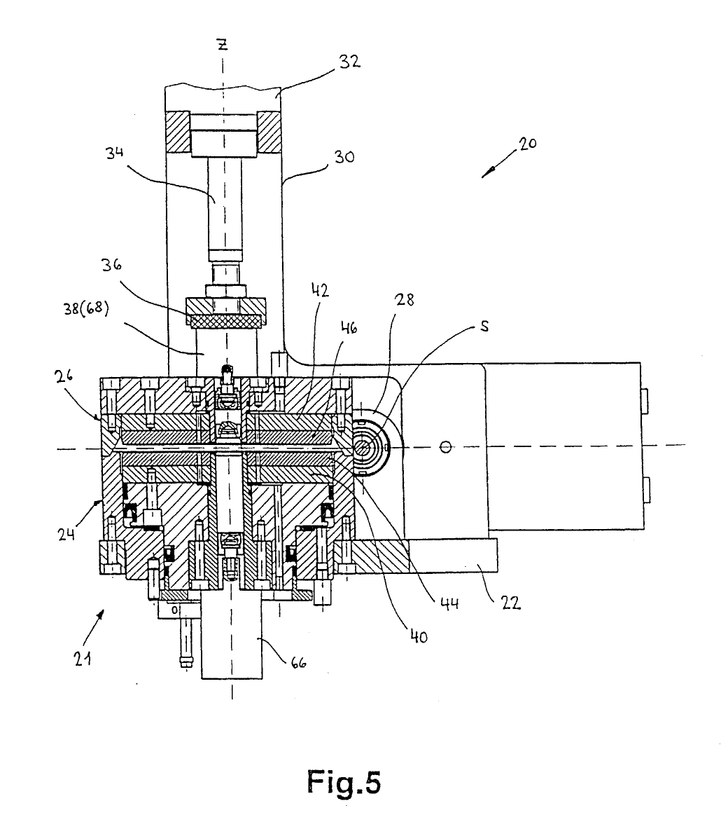

FIG. 5 a partially sectioned side view of the joining chamber of the joining station of FIG. 2,

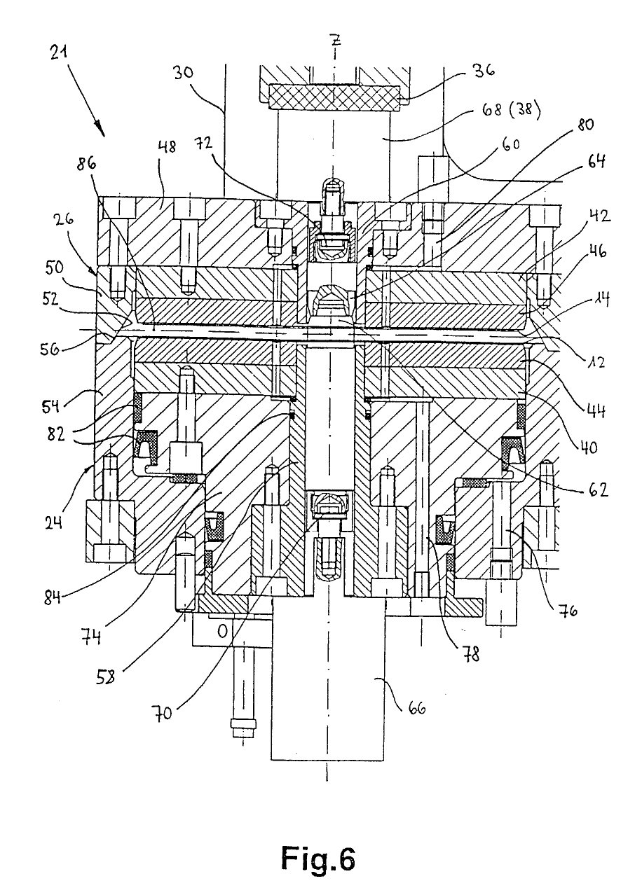

FIG. 6 a cross section through the joining chamber of FIG. 5 before the joining stroke,

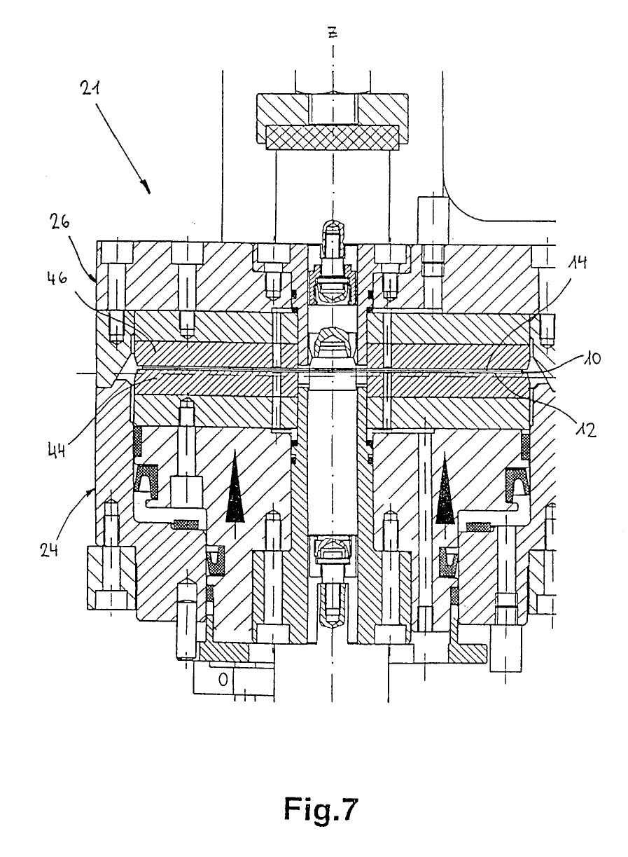

FIG. 7 a cross section through the joining chamber of FIG. 5 after the joining stroke.

A disk-shaped data carrier 10 of DVD type depicted in FIG. 1 comprises a support disk 12 and a data disk 14, which are joined via a hotmelt adhesive layer 16 to form a disk composite. The support disk 12 can fundamentally be a second data disk. The two disks 12, 14 are comprised for example of polycarbonate and are additionally metallized. For subsequent positioning in a read or playback apparatus the disks 12, 14 adhered with one another, and thus also the disk-shaped data carrier 10, comprise a central opening 18.

A joining station 20 depicted in FIGS. 2 to 4 with a joining chamber 21 in different stages of opening is built on a base plate 22, on which a joining shell 24 of the joining chamber 21 is stationarily mounted. Closing of the joining chamber 21 takes place with a cover 26, which is set onto the joining shell 24 by means of a rotating loader 28 by pivoting about a rotational axis s.

From the base plate 22 projects a carrier 30 as a mounting for a pneumatic lifting cylinder 32. The lifting cylinder 32 comprises a piston rod 34 with a pressing ram 36 which, as evident in FIG. 5, during the joining process explained in further detail in conjunction with FIGS. 6 and 7, is in contact on an abutment 38 disposed on the cover 26 of the joining chamber 21.

The joining chamber 21 depicted in detail in FIGS. 6 and 7 comprises a lower seating plate 40 disposed in the joining shell 24 as well as an upper seating plate 42 disposed in cover 26. The surfaces of both seating plates 40,42 are each formed by a pad 44, 46. These pads 44, 46 have a thickness of for example 8 mm and comprise for example polyurethane with a hardness of 70 Shore and are completely surface-ground.

The cover 26 comprises a bottom plate 48 and an encircling rim 50 projecting up from it, whose inner face 52 is conically expanded toward the free end. The wall 54 of the joining shell 24 has a counter face 56 directed correspondingly conically inwardly, which upon closing the joining chamber 21 comes into contact with the conical inner face 52 on cover 26 such that joining shell 24 and cover 26 are implemented to be aligned self-centeringly plane-parallel with respect to one another. Cover 26 is supported on the joining shell 24 such that it is movable in four degrees of freedom, namely with respect to planarity (x, y) and tilt (x, y). Via the cone the disks (DVD halves) 12, 14 are centered and via the seating faces (innerface 52, counterface 56) planarly oriented. Priority is plane-parallelity; the centricity has a tolerance of approximately 20 to 40 μm.

Fixedly connected with the joining shell 24 is a sleeve 58 disposed centrally in the lifting axis z. In the same manner a sleeve 60 is disposed in the cover. The two sleeves 58, 60 serve for the receiving and the sliding bearing of one centering pin each 62, 64. The lower centering pin 62 is provided with a conically developed point. The upper centering pin 64 is provided at its point with a recess whose contour corresponds to the conical point of the lower centering pin 62.

The two centering pins 62, 64 are connected via bearings 70, 72 with one lifting cylinder 66, 68 each for executing the displacement movement within sleeves 58, 60.

A pressing piston 74 fixedly connected with the lower seating plate 40 is guided slidingly via sealing rings 82, 84 on the inner wall of joining shell 24 and on the outer perimeter of sleeve 58 and displaceable via a pneumatic connection 76 in the lifting axis Z.

At the surfaces of pads 44, 46 on the seating plates 40, 42 terminate suction lines 78, 80, via which an underpressure can be generated on the backside of the emplaced disks 12, 14 for securing the disks during the closing process of the joining chamber 21. A further suction line, not shown in the drawing, serves for generating a vacuum of the interspace 86 present between the seating plates 40, 42 or the pads 44, 46 before the joining stroke.

In the following the operational function will be described of the joining station 20 depicted in FIGS. 2 to 4 with the joining chamber depicted in detail in FIGS. 6 and 7.

The disks (DVD halves) 12,14 emerging from a hotmelt installation and provided with a layer of an adhesive agent, are placed by means of a grasping mechanism onto pads 44, 46 in the joining shell 24 or in the cover 26 of the open joining chamber 21. As soon as the grasping mechanism which deposits the disks 12,14 leaves the joining region the lower and the upper centering pins 62, 64 extend out and therewith center the disks 12, 14 by means of their central openings 18 on pads 44, 46. Herein the two disks are held on the pads 44, 46 via the suction lines 78, 80 by means of a vaccum. The centering pins 62, 64 are subsequently again retracted. The joining chamber 21 is now closed by means of the pneumatically driven rotational loader 28. Upon the situation of proximity of the cover 26 to the joining shell 24 an automatic precentering takes place via the conical structuring of the inner face 52 on cover 26 and the conical counter face 56 on the joining shell.

As soon as the joining chamber 21 is closed, the lower centering pin 62 is again extended out and retracted into the upper centering pin 64. Due to the conical structuring of the point of the lower centering pin 62 and the likewise conical structuring of the recess at the point of the upper centering pin 64 a self-centering takes place upon the situation of proximity of the two centering pins 62, 64. Herein takes place a form-fit closure between the two centering pins 62, 64, which leads to a precise mutual positioning of the disks 12, 14 to be adhered with one another. In this form-fit position of the two centering pins 62, 64, the suction lines 80 terminating on the surface of the upper pad 46 are vented such that the disk 14 held by the vacuum in cover 26 “falls” onto the lower disk 12. During this process in the interspace 86 between pads 44, 46 in joining chamber 21 a vacuum is generated in order for the two disks 12, 14 to be joined without air inclusions in the adhesive agent.

After the two disks 12, 14 are in contact with one another on the lower pad 44, the lifting cylinder 32 is actuated and the piston rod 34 extended out until the terminal pressing ram 36 is in contact on the upper lifting cylinder 68, serving as abutment 38, for the upper centering pin 64. The pressing and joining piston 74 is subsequently impressed with compressed air via the pneumatic line 76. Through the pressing force generated thus the two disks (DVD halves) 12, 14 are joined. With this configuration the pressing station provided in DE-U 299 04 325 can be omitted.

After the joining time the lower centering pin 62 is again retracted, the compressed air on joining piston 74 switched off and the piston rod 34 with pressing ram 36 is raised again. The joining chamber 21 is subsequently flushed with air and subsequently the cover 26 pivoted back again, i.e. the joining chamber 21 is opened. The finished disk composite (DVD) 10 is subsequently removed by a grasping mechanism and the joining chamber 21 is ready to receive the next two disks 12, 14.

1. Device for joining two disks (12,14), coated with an adhesive agent (16) and provided with a central opening (18) and comprised of a material of which synthetic materials are a substantial component, to form a disk-shaped data carrier (10), with two retaining elements (40,42) for the temporary retaining of the disks (12,14) to be adhered with one another, with the retaining elements (40, 42) having a planar surface as seating faces for the disks (12,14) coated with the adhesive agent (16), and suction lines (78, 80) for generating an underpressure retaining the disks (12, 14) on the seating faces terminating on the surface of the seating faces, with each retaining element (40, 42) being disposed within a chamber half (24, 26) and after closure forming a joining chamber (21) with an evacuatable interspace (86), with each chamber half (24, 26) comprising a centering pin (62, 64) penetrating the retaining elements (40, 42) for centering the disks (12, 14) on the retaining elements, and with at least one retaining element (40) being movable in its chamber half (24) in the direction (z) toward the other retaining element (42) for the purpose of joining the adhesive-coated disks 12, 14), characterized in that the centering pins (62, 64) can be retracted beneath the seating face of the retaining elements (40, 42) and their front faces opposing one another when the joining chamber (21) is closed are implemented such that they self-centeringly can engage into one another.

2. Device as claimed in claim 1, characterized in that each centering pin (62, 64) is displaceable in the axial direction (z) by means of a lifting mechanism (66, 68).

3. Device as claimed in claim 2, characterized in that the centering pins (62, 64) are slidingly supported in a sleeve (58, 60).

4. Device as claimed in one of claims 1 to 3, characterized in that the at least one retaining element (40) is in contact on a joining piston (74) movable in the axial direction (z) or is formed by it.

5. Device as claimed in claim 3 and 4, characterized in that the joining piston (74) is slidingly supported between the inner wall of a chamber half (24) and the outer surface of the associated sleeve (58).

6. Device as claimed in claim 4 or 5, characterized in that the joining piston (74) is pneumatically actuatable.

7. Device as claimed in one of claims 1 to 6, characterized in that the seating faces of the retaining elements (40, 42) are formed as pads (44, 46) by a surface-ground synthetic seating.

8. Device as claimed in claim 7, characterized in that the pads (44, 46) are approximately 1 to 8 mm thick and have a hardness of approximately 60 to 90 Shore.

9. Device as claimed in claim 7 or 8, characterized in that the pads (44, 46) are comprised of polyurethane, silicon or fluorine rubber, optionally electrically conducting.

10. Device as claimed in one of claims 1 to 9, characterized in that the two chamber halves (24, 26) can be pivoted about a common rotational axis (s) from the open into the closed position.

11. Device as claimed in one of claims 1 to 10, characterized in that the margin regions of the joining shell (24) and of the cover (26) opposing one another during the closing of the joining chamber (21) are implemented to engage one another self-centeringly and to be orientable plane-parallel to one another.

12. Use of the device as claimed in one of claims 1 to 11 for the production of disk-shaped data carriers (10) of the DVD type.
